(19) United States
(12) Patent Application Publication
(10) Pub. No.: US 2022/0067754 A1
(43) Pub. Date: Mar. 3, 2022

(54) COMPUTERIZED SYSTEMS AND METHODS FOR PREDICTING A MINIMUM DETECTABLE EFFECT

(71) Applicant: COUPANG CORP., Seoul (KR)

(72) Inventors: Xiaowei GONG, San Jose, CA (US); Beibei YE, Fremont, CA (US); Jun YE, Fremont, CA (US); Chul SEO, San Carlos, CA (US)

(73) Assignee: Coupang Corporation

(21) Appl. No.: 17/005,232

(22) Filed: Aug. 27, 2020

(51) Int. Cl. G06Q 30/02; G06F 16/955; G06F 16/958

(52) U.S. Cl. CPC G06Q 30/0201; G06F 16/958; G06F 16/955

(57) ABSTRACT

Embodiments of the present disclosure include computer-implemented systems and methods for predicting a minimum detectable effect. The system may include at least one processor configured to execute instructions to perform steps. The steps may include sending a first webpage to a first user device and a second webpage to a second user device. The second webpage may include at least one characteristic different than the first website. The steps may include collecting user interaction data from the first and second user devices and determining a current minimum detectable effect of a user experience. The steps may include retrieving a set of historic minimum detectable effect values associated with an earlier period of time and determining a percentile rank of the current minimum detectable effect based on the retrieved set of historic minimum detectable effect values. The steps may include predicting a first and second future value of the minimum detectable effect of the user experience and aggregating the first and second future values. The aggregated first and second future value may be compared with a threshold to determine whether or not to stop an experiment and implement a change on a website.

### TECHNICAL FIELD

The present disclosure generally relates to computerized systems and methods for determining a minimum detectable effect. In particular, embodiments of the present disclosure relate to inventive and unconventional systems and methods for predicting a minimum detectable effect of a currently running experiment.

### BACKGROUND

With the advancement and widespread acceptance of e-commerce, Internet shopping offers a one-stop shop for all shopping needs including food, furniture, electronics, clothes, books, etc. In order to optimize and enhance a customer's experience online, many e-commerce companies utilize design of experiments (DOEs) to understand the behavioral patterns of their customers. Some e-commerce companies may utilize A/B testing of their webpages to understand how customers respond to changes of specific webpage elements. An A/B test is an experiment that includes a comparison between two versions of the same marketing asset, such as a social media post, email, or webpage. In a conventional A/B test, half of the visitors to a website are presented with a standard webpage and half of the visitors are presented with a variation of the standard webpage. Based on conversion rates or other metrics a determination may be made on which webpage performs best. For example, if the goal of the website is to encourage more subscribers, and the website with the variation leads to more subscribers than the standard website, then the variation may be deemed successful and implemented on the website in perpetuity. A/B testing may allow e-commerce companies to construct hypotheses and learn why certain elements positively or negatively impact customers' behaviors. Understanding the reaction of customers may lead to a webpage design that maximizes profits by attracting customers who positively respond to the changes in the webpage.

However, while DOEs or A/B testing for webpages are useful, they require a lot of resources and time to run. DOEs or A/B testing may require long experiment test times in order to obtain enough data to make a decision on whether or not a variable makes a significant impact. For example, some experiment tests may last as long as six months to recover enough significant statistical data to make a proper decision on which variation has the most positive impact on customers. P-values are often used to evaluate whether an experiment has run long enough to reach a conclusion that is statistically significant. Typically, a p-value lower than 0.05 is considered statistically significant. When a p-value lower than 0.05 is achieved an experiment may be considered a success and ended. However, not all experiments are able to collect enough data, or have enough sample size, to achieve a p-value less than 0.05. In these cases, it is useful to predict a minimum detectable effect to aid in determining whether or not to stop an experiment.

Therefore, there is a need for improved methods and systems for predicting a minimum detectable effect of an experiment.

### SUMMARY

One aspect of the present disclosure is directed to a computer-implemented system for determining a minimum detectable effect. The system may include memory comprising processor instructions and at least one processor configured to execute the instructions to perform steps. The steps may include sending a first webpage to a first user device and sending a second webpage to a second user device. The second webpage may include at least one characteristic different than the first website. The steps may include collecting user interaction data from the first and second user devices. The steps may include determining from the user interaction data a current minimum detectable effect of success metrics indicative of a user experience. The steps may include retrieving a set of historic minimum detectable effect values for the success metrics associated with an earlier period of time. The steps may include determining a percentile rank of the current minimum detectable effect based on the retrieved set of historic minimum detectable effect values. The steps may include predicting a first future value of the minimum detectable effect of the user experience and predicting a second future value of the minimum detectable effect of the user experience. The steps may include aggregating the first and second future values of the minimum detectable effect of the user experience and determining a termination condition based on the current minimum detectable effect and the aggregated value (or predicted MDEs). The steps may include ceasing the sending of the second webpage to the second user device if the termination condition exists.

Another aspect of the present disclosure is directed a computer-implemented method for determining a minimum detectable effect. The method may include sending a first webpage to a first user device and sending a second webpage to a second user device. The second webpage may include at least one characteristic different than the first webpage. The method may include collecting user interaction data from the first and second user devices. The method may include determining from the user interaction data a current minimum detectable effect of success metrics indicative of a user experience. The method may include retrieving a set of historic minimum detectable effect values for the success metrics associated with an earlier period of time. The method may include determining a percentile rank of the current minimum detectable effect based on the retrieved set of historic minimum detectable effect values. The method may include predicting a first future value of the minimum detectable effect of the user experience and predicting a second future value of the minimum detectable effect of the user experience. The method may include aggregating the first and second future values of the minimum detectable effect of the user experience and determining a termination condition based on the current minimum detectable effect and the aggregated value. The method may include ceasing the sending of the second webpage to the second user device if the termination condition exists.

Yet another aspect of the present disclosure is directed to directed to a computer-implemented system for determining a minimum detectable effect. The system may include memory comprising processor instructions and at least one processor configured to execute the instructions to perform steps. The steps may include sending a first webpage to a first user device and sending a second webpage to a second user device. The second webpage may include at least one characteristic different than the first website. The steps may include collecting user interaction data from the first and second user devices. The steps may include determining from the user interaction data a current minimum detectable effect of success metrics indicative of a user experience. The steps may include retrieving a set of historic minimum detectable effect values for the success metrics associated with an earlier period of time. The steps may include determining a percentile rank of the current minimum detectable effect based on the retrieved set of historic minimum detectable effect values. The steps may include predicting a first future value of the minimum detectable effect of the user experience and predicting a second future value of the minimum detectable effect of the user experience. The steps may include aggregating the first and second future values of the minimum detectable effect of the user experience. The steps may include determining, based on the current minimum detectable effect and the aggregated first and second future values of the minimum detectable effect of the user experience, to continue sending the second webpage to the second user device if the current minimum detectable effect and the aggregated first and second future values are not indicative of a termination condition, and cease sending the second webpage to the second user device if the current minimum detectable effect and the aggregated first and second future values are indicative of a termination condition.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 depicts a block diagram illustrating an exemplary system for predicting a minimum detectable effect, consistent with the disclosed embodiments.

FIG. 4 depicts a sample Search Result Page (SRP) that forms part of an A/B testing experiment, consistent with the disclosed embodiments.

FIG. 5 depicts an illustration showing historical minimum detectable effects for a plurality of A/B testing experiments.

FIG. 6 depicts an illustration showing historic minimum detectable effect values alongside a minimum detectable effect of a current A/B testing experiment, consistent with the disclosed embodiments.

FIG. 7 is a flow chart of an exemplary method for predicting a minimum detectable effect, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for reducing cycle time and enhancing efficiency of package delivery by individually shipping items of the same order without waiting for the remaining items, thus avoiding slowing down computerized systems and processes.

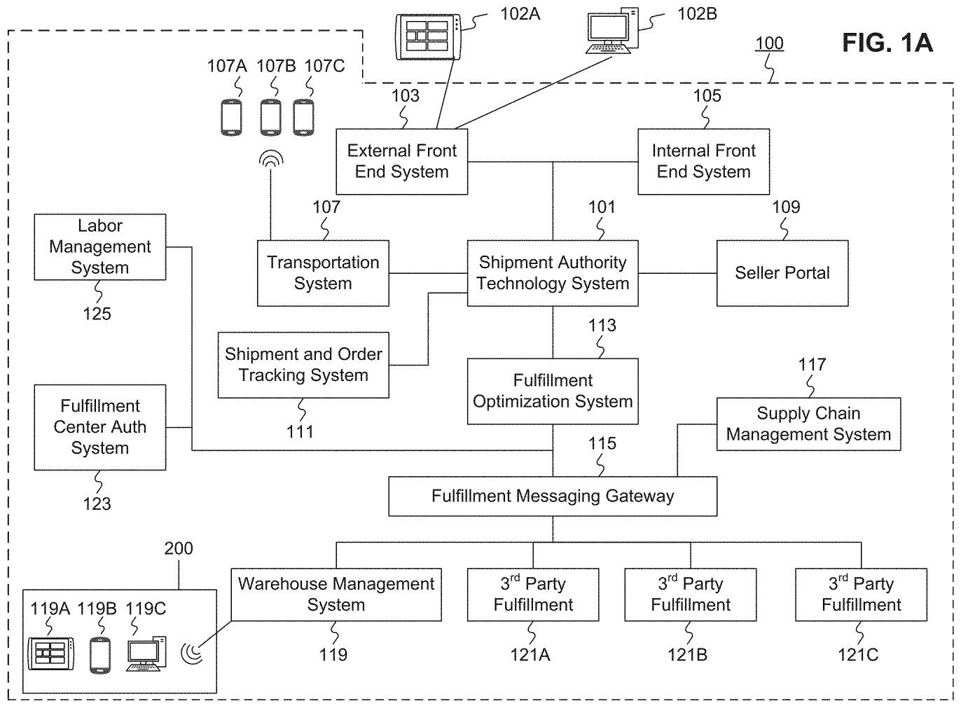

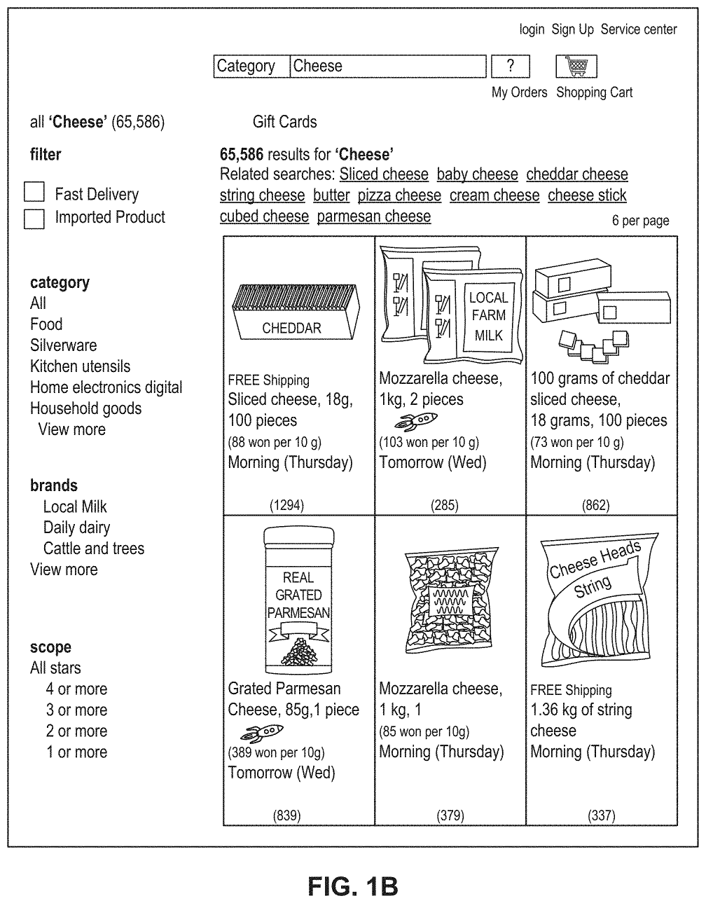

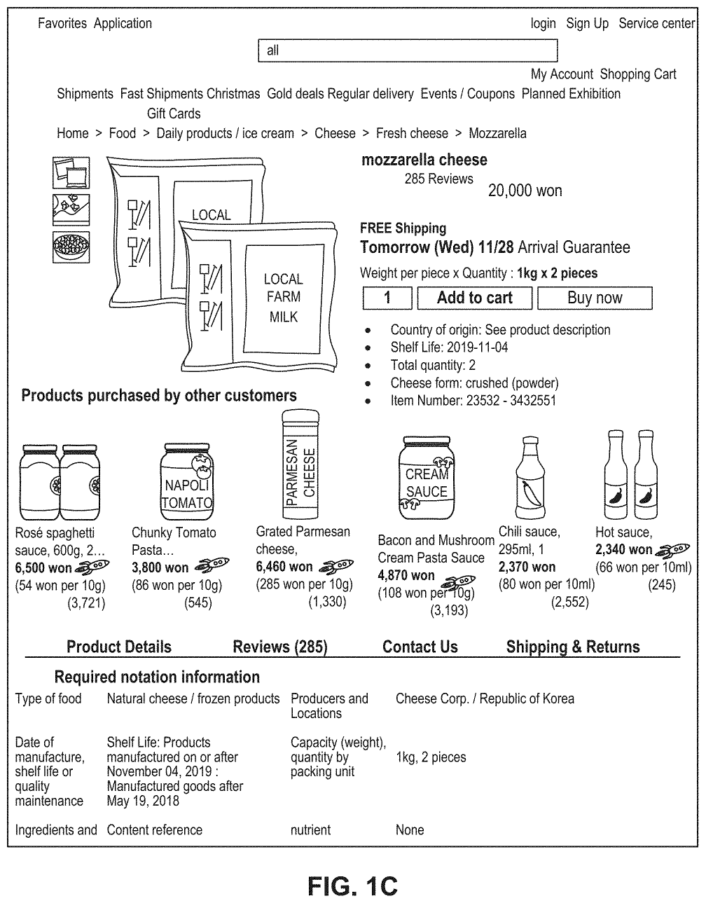

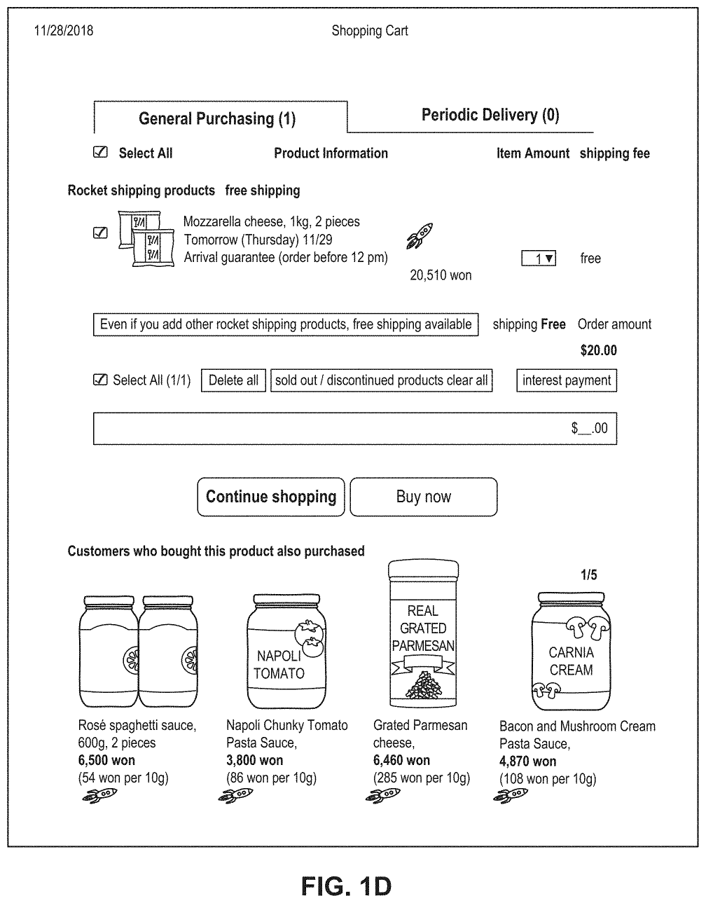

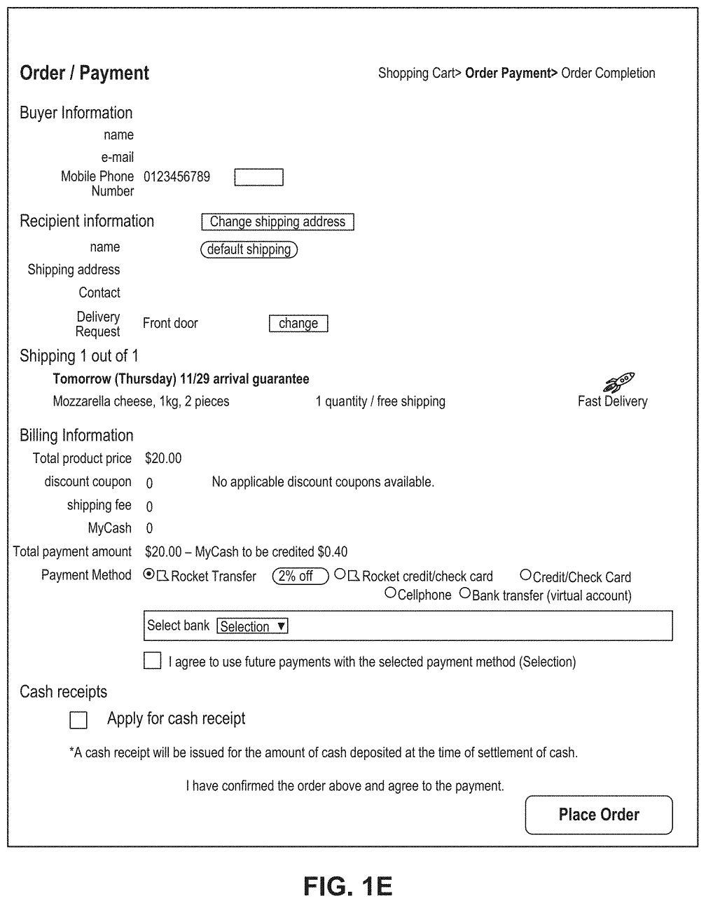

Referring to FIG. 1A, a schematic block diagram 100 illustrating an exemplary embodiment of a network comprising computerized systems for communications enabling shipping, transportation, and logistics operations is shown. As illustrated in FIG. 1A, system 100 may include a variety of systems, each of which may be connected to one another via one or more networks. The depicted systems include a shipment authority technology (SAT) system 101, an external front-end system 103, an internal front end system 105, a transportation system 107, mobile devices 107A, 1078, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front-end system 103 and FO system 113.

External front-end system 103, in some embodiments, may be implemented as a computer system that enables external users to interact with one or more systems in network 100. For example, in embodiments where network 100 enables the presentation of systems to enable users to place an order for an item, external front-end system 103 may be implemented as a web server that receives search requests, presents item pages, and solicits payment information. For example, external front-end system 103 may be implemented as a computer or computers running software such as the Apache HTTP Server, Microsoft Internet Information Services (IIS), NGINX, or the like. In other embodiments, external front-end system 103 may run custom web server software designed to receive and process requests from external devices (not depicted), acquire information from databases and other data stores based on those requests, and provide responses to the received requests based on acquired information.

In some embodiments, external front-end system 103 may include one or more of a web caching system, a database, a search system, or a payment system. In one aspect, external front-end system 103 may comprise one or more of these systems, while in another aspect, external front-end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front-end system 103. External front-end system 103 may receive information from systems or devices in network 100 for presentation and/or display. For example, external front-end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front-end system 103 and request a search by entering information into a search box. External front-end system 103 may request information from one or more systems in network 100. For example, external front-end system 103 may request results from FO System 113 that satisfy the search request. External front-end system 103 may also request and receive (from FO System 113) a Promised Delivery Date or “PDD” for each product returned in the search results. The PDD, in some embodiments, represents an estimate of when a package will arrive at the user's desired location if ordered within a particular period of time, for example, by the end of the day (11:59 PM). (PDD is discussed further below with respect to FO System 113.)

External front-end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front-end system 103 may deliver the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front-end system 103. In response, external front-end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front-system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. External front-end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front-end system 103.

External front-end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front-end system 103.

External front-end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front-end system 103 may send the Order page to the user device.

The user device may enter information on the Order page and click or otherwise interact with a user interface element that sends the information to external front-end system 103. From there, external front-end system 103 may send the information to different systems in network 100 to enable the creation and processing of a new order with the products in the shopping cart.

In some embodiments, external front-end system 103 may be further configured to enable sellers to transmit and receive information relating to orders.

Internal front-end system 105, in some embodiments, may be implemented as a computer system that enables internal users (e.g., employees of an organization that owns, operates, or leases network 100) to interact with one or more systems in network 100. For example, in embodiments where network 101 enables the presentation of systems to enable users to place an order for an item, internal front-end system 105 may be implemented as a web server that enables users to view diagnostic and statistical information about orders, modify item information, or review statistics relating to orders. For example, internal front-end system 105 may be implemented as a computer or computers running software such as the Apache HTTP Server, Microsoft Internet Information Services (IIS), NGINX, or the like. In other embodiments, internal front-end system 105 may run custom web server software designed to receive and process requests from devices depicted in network 100 (as well as other devices not depicted), acquire information from databases and other data stores based on those requests, and provide responses to the received requests based on acquired information.

In some embodiments, internal front-end system 105 may include one or more of a web caching system, a database, a search system, a payment system, an analytics system, an order monitoring system, or the like. In one aspect, internal front-end system 105 may comprise one or more of these systems, while in another aspect, internal front-end system 105 may comprise interfaces (e.g., server-to-server, database-to-database, or other network connections) connected to one or more of these systems.

Transportation system 107, in some embodiments, may be implemented as a computer system that enables communication between devices in network 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature. The mobile device may send a communication to transportation system 107 including information about the delivery, including, for example, time, date, GPS location, photo(s), an identifier associated with the delivery worker, an identifier associated with the mobile device, or the like. Transportation system 107 may store this data in a database (not pictured) for access by other systems in network 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store a relationship between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this relationship in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other outside entities to electronically communicate with other aspects of information relating to orders. For example, a seller may utilize a computer system (not pictured) to upload or provide product information, order information, contact information, or the like, for products that the seller wishes to sell through system 100.

Shipment and order tracking system 111, in some embodiments, may be implemented as a computer system that receives, stores, and forwards information regarding the location of packages ordered by customers (e.g., by a user using devices 102A-102B). In some embodiments, shipment and order tracking system 111 may request or store information from web servers (not pictured) operated by shipping companies that deliver packages ordered by customers.

In some embodiments, shipment and order tracking system 111 may request and store information from systems depicted in network 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual packages inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end-system 103 and/or shipment and order tracking system 111). FO system 113 may also store information describing where particular items are held or stored. For example, some items that customers order may be stored only in one fulfillment center, while other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end-system 103, SAT system 101, shipment and order tracking system 111). In other embodiments, FO system 113 may receive electronic requests from one or more systems (e.g., external front-end system 103, SAT system 101, shipment and order tracking system 111) and calculate the PDD on demand.

Fulfilment messaging gateway (FMG) 115, in some embodiments, may be implemented as a computer system that receives communications from one or more systems in network 100, such as FO system 113, converts the data in the communications to another format, and forward the data in the converted format to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may determine forecasted level of demand for a particular product based on, for example, based on a past demand for products, an expected demand for a product, a network-wide past demand, a network-wide expected demand, a count of products stored in each fulfillment center 200, expected or current orders for each product, or the like. In response to this determined forecasted level and the amount of each product across all fulfillment centers, SCM system 117 may generate one or more purchase orders to satisfy the expected demand for a particular product.

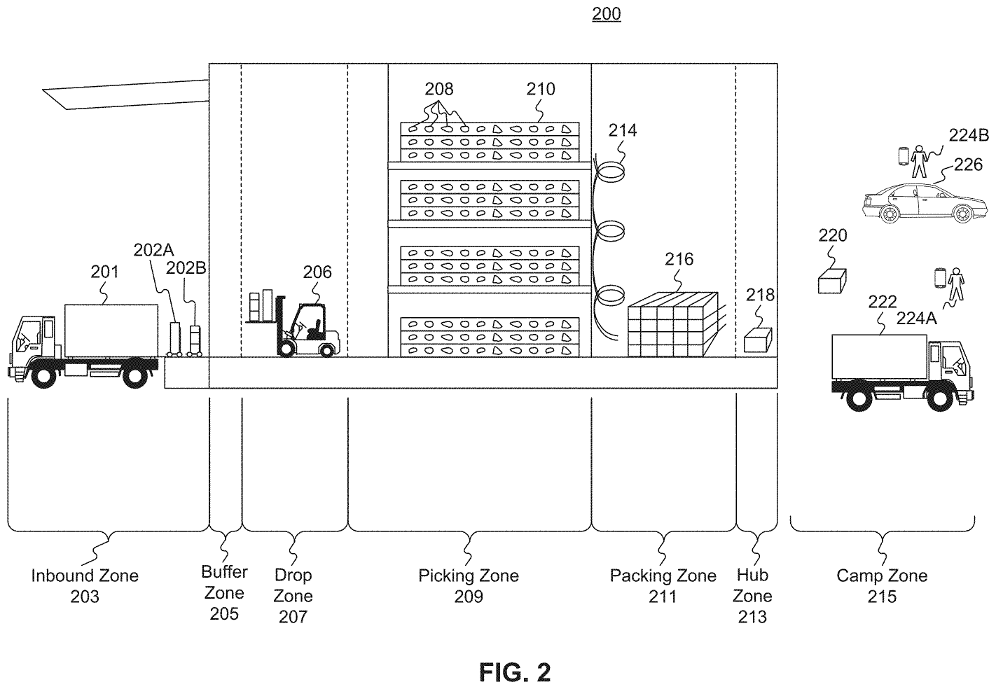

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with network 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with network 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly.

Fulfillment Center Auth system (FC Auth) 123, in some embodiments, may be implemented as a computer system with a variety of functions. For example, in some embodiments, FC Auth 123 may act as a single-sign on (SSO) service for one or more other systems in network 100. For example, FC Auth 123 may enable a user to log in via internal front-end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113 through FMG 115, not all embodiments require this particular configuration. Indeed, in some embodiments, the systems in network 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in network 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So, while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using network 100 from FIG. 1. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the drop zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1 indicating that item 202A has been stowed at the location by the user using device 1196.

Once a user places an order, a picker may receive an instruction on device 1196 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

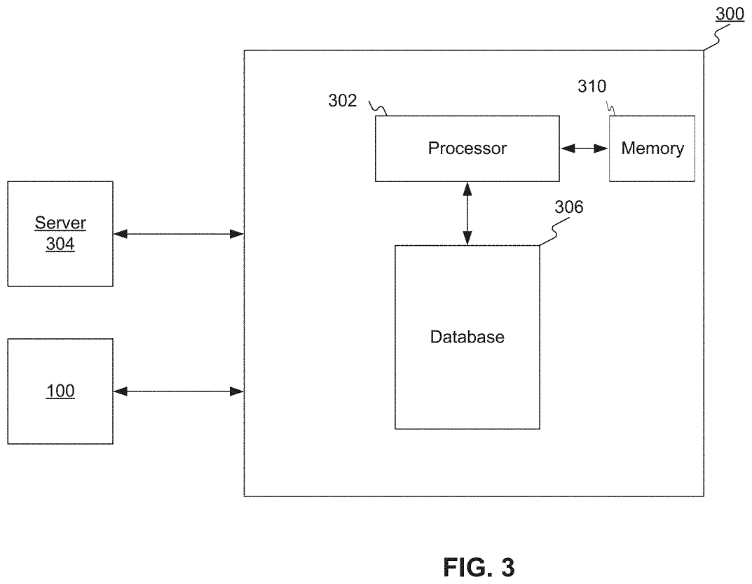

FIG. 3 is a block diagram illustrating an exemplary system 300 for predicting a minimum detectable effect during an experiment, consistent with the disclosed embodiments. System 300 may be separate from, or incorporated into a portion of system 100, such as internal front end system 105. System 300 may include one or more processors 302 configured to determine a minimum detectable effect of one or more success metrics indicative of a user experience during a current or active A/B test or design of experiment test conducted on system 100. System 300 may include a memory 310 which includes processor instructions. System 300 may include a database 306. Database 306 may comprise one or more local or remote databases configured to store data associated with current or previously performed A/B test or testing experiment data. For example, database 306 may include historic minimum detectable effect values for success metrics from a plurality of previously performed A/B tests or testing experiments. Database 306 may be continuously updated (e.g., by system 300, external front end system 103, or internal front end system 105) to include data from current or recently completed A/B tests or testing experiments. The current or active A/B test or design of experiment test may be conducted on external front end system 103. For example, a current or active A/B test may include presenting a portion of customers or site visitors with one version of a webpage, a mobile application, or other marketing asset, and presenting another portion of customers or site visitors with a second version of the webpage, mobile application, or other marketing asset having at least one different characteristic. System 300 may monitor and record any data related to interaction of the customers with the webpages, mobile applications, or other marketing assets. User interaction data, such as time spent on a page, links clicked, items purchased, subscriptions joined, posts to social media, conversion rate, bounce rate, exit rate, and any other quantifiable data associated with navigating a webpage may be collected and recorded, for example on server 304. System 300, external front end system 103, or internal front end system 105 may collect the user interaction data and store the data on server 304, in database 306, or in another data storage location for later retrieval. Server 304 may communicate with one or more databases or other memory storage devices. The one or more databases or other memory storage devices may be remote, such as on the cloud, or local. System 300 may utilize the interaction data to determining if the at least one different characteristic is indicative of an increased user experience, and then apply at least one characteristic to a third webpage, mobile application, or other marketing asset.

A current or active A/B test or testing experiment may include any A/B test or testing experiment that is currently or actively being presented to one or more customers or visitors to a webpage or other marketing asset. In some aspects, A/B testing experiments may divide the traffic to the marketing asset equally. For example, in some aspects, 50% of the customers or visitors may be presented with a first version of the marketing asset and 50% of the customers or visitors may be presented with the second version of the marketing asset. In other aspects, A/B testing experiments may divide the traffic to the marketing asset unequally. For example, 30% of the customers or visitors may be presented with a first version of the marketing asset and 70% of the customers or visitors may be presented with the second version of the marketing asset. A/B testing experiments may include two or more versions of a marketing aspect and may test more than one variable of a marketing aspect. For example, an A/B test or testing experiment may test a first version against a second version having a change in one variable, or an A/B test or testing experiment may test a first version against a second version having a change in one variable, a third version having a change in two variables, and a fourth version having a change in ten variables. There is no limitation on the number of variables that may be modified or varied for testing, or the number of versions of the marketing aspect that may be displayed to different customers or visitors.

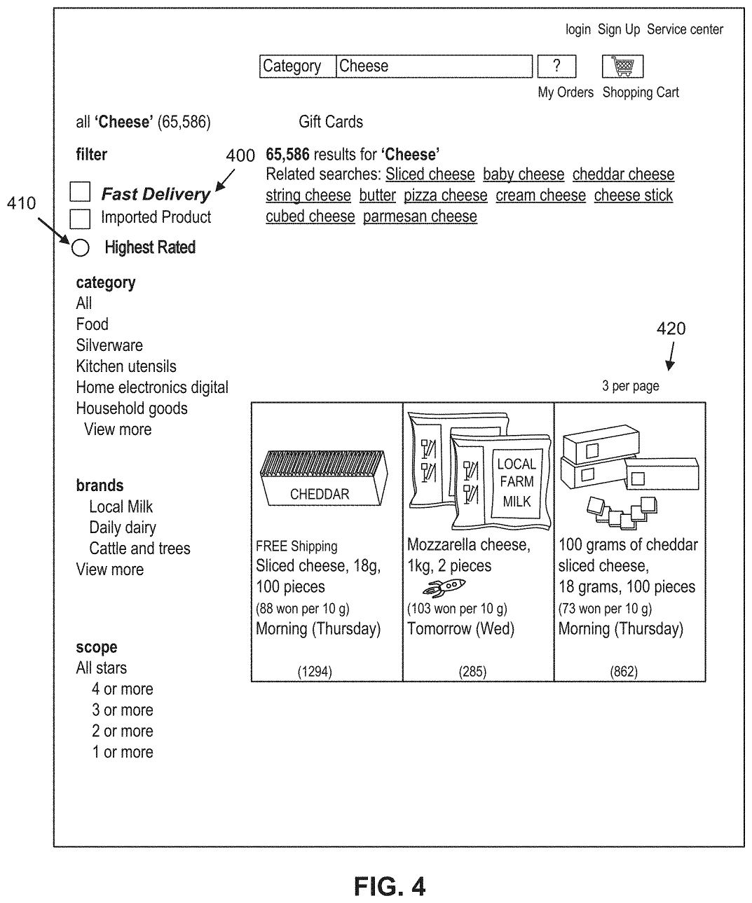

FIG. 4 depicts a sample Search Result Page (SRP) 400 that forms part of a current or active A/B testing experiment. In this example, the SRP shown in FIG. 1B may be presented to a first user device, while SRP 400 is displayed to a second user device. SRP 400 is similar to the SRP shown in FIG. 1B, but includes at least one characteristic different than the first website. SRP 400 includes at least one modified variable in order to test the effects of the modification. For example, as shown a 410, the font of “Fast Deliver” is modified to be bold and italicized. Additionally, a new category “Highest Rated,” along with a differently shape checkbox, has been added to the SRP 400 at 420. Another modification includes only displaying 3 search results per page as indicated at 430, rather than 6 per page as illustrated in FIG. 1B. The search results are also shown in a different, more central location. User interaction data may be collected by one or more portions of system 100, for example by external front end system 103 or internal front end system 105, from the first and second user devices and may be stored in one or more memory storage devices. User interaction data may include any data related to user interaction with the SRP shown in FIG. 1B and SRP 400. System 300, external front end system 103, or internal front end system 105 may use the user interaction data to make a determination on whether or not the changes shown at 400, 410, and 420 made a difference in a user's experience. For example, the user interaction data may show that it took less time for a user to complete a purchase of an item when the highest rated category was selected. It is understood that the changes in the variables shown in relation to FIG. 4 are merely for illustrative purposes only, and do not limit the type of variable or modifications that can be made between a first marketing aspect and a second marketing aspect.

In the event that there is not enough data to make a determination on whether or not a modification leads to a statistically significant impact, it may be beneficial to analyze the minimum detectable effect to decide whether or not to end a current A/B testing experiment. In this situation, being able to predict or forecast a minimum detectable effect allows for more decisive decision making. The present system and method relies upon historical minimum detectable effect values to aid in forecasting or predicting a minimum detectable effect for a current A/B testing experiment as discussed below.

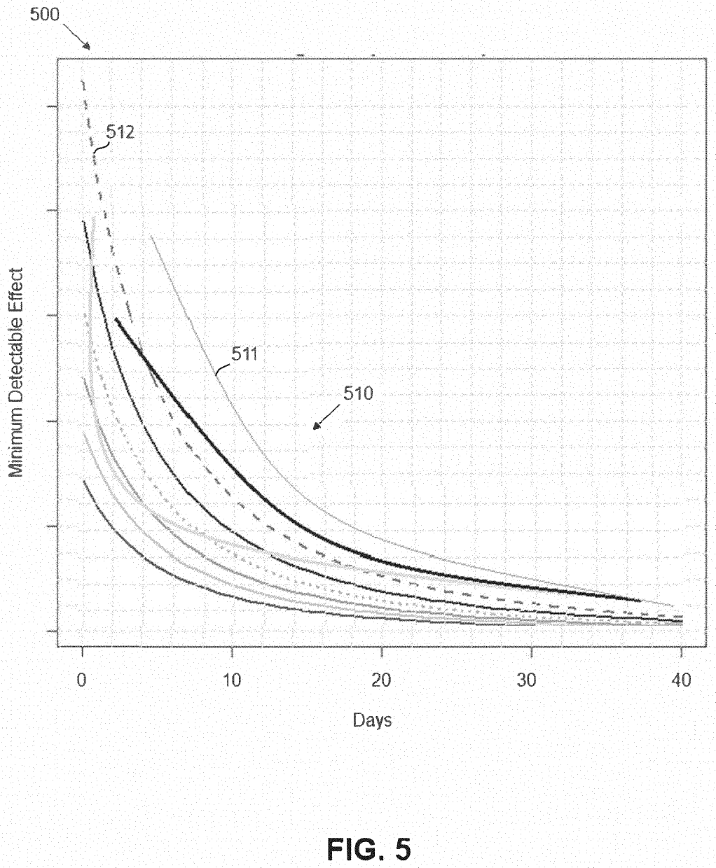

FIG. 5 depicts an illustration 500 showing stored example historical minimum detectable effects values 510 for a plurality of A/B testing experiments. The historical minimum detectable effect values 510 may be related to one or more success metrics indicative of a user experience. A success metric may include any metric that utilizes user interaction data to evaluate the results of an experiment. For example, a success metric may include the number of items purchased in a given time frame.

In FIG. 5, each line displayed on graph 500 represents the minimum detectable effect values for a previously performed A/B test or testing experiment, or different iterations of an A/B test or testing experiment. As noted above, the minimum detectable effect values may be associated with one or more success metrics from previously performed A/B testing experiments. The minimum detectable effect values 510 may be related to the same or similar success metrics. In this example, minimum detectable effect values for a first A/B test or testing experiment are shown at 511, and minimum detectable effect values for a second A/B test or testing experiment is shown at 512. Alternatively, minimum detectable effect values for a first iteration of an A/B test or testing experiment are shown at 511, and minimum detectable effect values for a second iteration of an A/B test or testing experiment are shown at 512. In the graph 500, the minimum detectable effect is shown on the y-axis, and the running days of the experiments are shown along the x-axis. As can be seen in FIG. 5, the historical minimum detectable effects 510 get smaller as the experiments run. This is partially a result of increased data being obtained for the experiment.

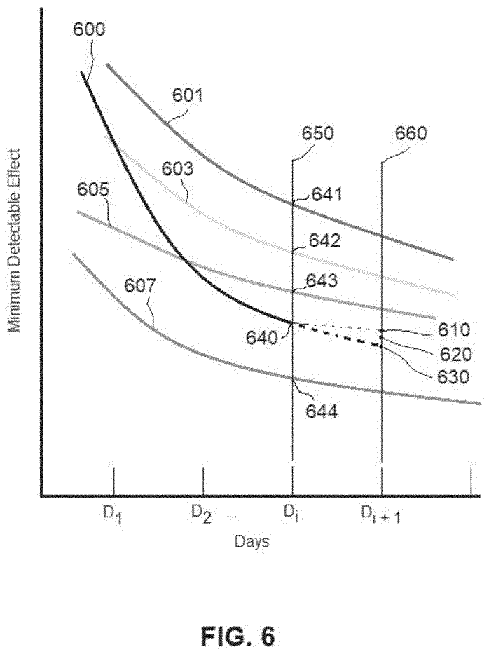

FIG. 6 depicts an illustration showing historic minimum detectable effect values 601, 603, 605, and 607 associated with the same or similar success metrics associated with previously performed A/B tests or testing experiments alongside a minimum detectable effect of the success metric from a current A/B testing experiment 600. The historic minimum detectable effect values may be for experiments similar to the current or active A/B testing experiment 600, and may be associated with one or more success metrics. In FIG. 6, the minimum detectable effect is shown on the y-axis, and the x-axis shows the running days of an experiment. In FIG. 6, the historic minimum detectable effect values 601, 603, 605, and 607 are displayed concurrently with a minimum detectable effect of a current A/B testing experiment 600 such that the days of each experiments align. For example, 650 illustrates a current day Dᵢ, and 660 illustrates a future day Dᵢ₊₁. The minimum detectable effect value that corresponds to the current day Dᵢ of historic minimum detectable effect values 601, 603, 605, and 607 are shown at 641, 642, 643, and 644 respectively. As can be seen, the minimum detectable effect value for the current A/B testing experiment for current day Dᵢ is shown at 640. It is noted, that while four historic minimum detectable effect values are shown for illustrative purposes only, this number may be greater or less. FIG. 6 is discussed below in regard to forecasting or predicting a minimum detectable effect.

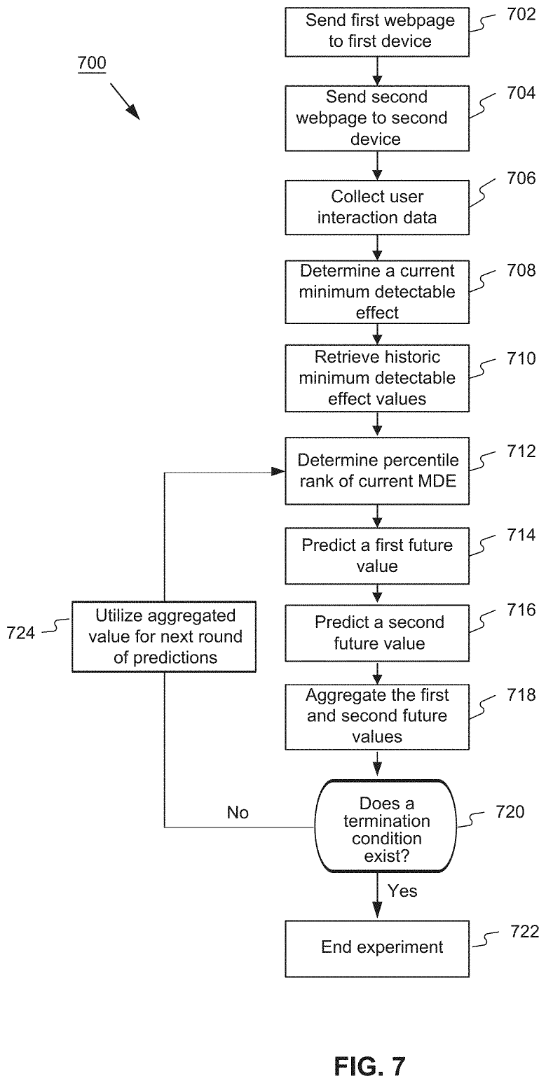

FIG. 7 is a flow chart of an exemplary method 700 for predicting a minimum detectable effect in accordance with one aspect of the disclosure. The method may be performed by at least one processor forming a part of system 100, for example, processor 302 or internal front end system 105. The at least one processor may execute instructions stored on a memory, such as memory 310. The instructions may be executed by more than one feature of system 100, such as external front end system 103 or internal front end system 105, by and may be executed over any wired or wireless communication channel. One of ordinary skill will understand that other systems or devices, including those described in FIG. 1A or FIG. 3 may perform one or more steps disclosed in FIG. 7. In one example, internal front end system 105 may be configured to perform A/B testing of different versions of a marketing aspect, such as a webpage, email, or social media post. Internal front end system 105 may collect data based on conversion rates or other metrics to determine which version of the marketing aspect performs better. Conversion rates may include a percentage of visitors who take a desired action. While not an exhaustive list, in some aspects, a desired action may include purchasing a product, registering for a membership, subscribing to a newsletter, downloading information, “liking” a post, clicking on a link, or saving an item in cart.

To begin method 700, processor 302 or internal front end system 105 may send a first webpage (or other marketing asset) to a first user device at step 702. The webpage may include any media, data, or document capable of being transmitted over the internet or other transmission platform. The webpage may include any combination of text, imagery, video, audio, links, hyperlinks, or any feature capable of being transmitted. In one aspect, the webpage may include a homepage, landing page, search result page, single display page, cart page, or any webpage associated with an online market, business, or platform. The webpage may also include an email or social media post. The first webpage may include a webpage that is in current use, or is a standard webpage for an online market, e-commerce company or business, or other entity having an online presence. The first user device may include any interface from which a user may access the Internet or World Wide Web, or may otherwise access and interact with first webpage. For example, first user device may include a mobile device 102A, computer 102B, tablet, PDA, smart phone, smart watch, or any other device capable of interacting with a marketing asset.

At step 704, internal front end system 105 may send a second webpage to a second user device. The second user device may include any interface from which a user may access the Internet or World Wide Web, or may otherwise access and interact with second webpage as discussed above. The second webpage may include at least one characteristic different than the first webpage. The difference may include a change or modification in any aspect of the first webpage. For example, the change or modification may include at least one difference in size, color, shape, position, location, order, spelling, wording, character, picture, image, frequency, level, brightness, hue, volume, visual feature, or audible feature of the webpage. In one aspect, the second webpage may be substantially similar to the first webpage, with a modification to at least one portion of the first webpage. In one example, FIG. 1B may be illustrative of a first webpage sent to a first user device and FIG. 4 may illustrative of a second webpage sent to a second user device. While SRP 400 is substantially similar to the SRP shown in FIG. 1B, meaning that SRP 400 is identical to the SRP in FIG. 1B in the majority of aspects, there are differences. For example, the font of “Fast Delivery” has been changed at 410, a new button or checkbox has been added to select new category “Highest Rated” at 410, and the results per page has been reduced to 3 at 420.

At step 706, user interaction data from the first and second user devices may be collected by system 300, external front end system 103, or internal front end system 105. User interaction data may include any information related to a user's interaction with a webpage. For example, user interaction data may include time spent on a page, links clicked, items purchased, posts to social media, conversion rate, bounce rate, exit rate, and any other quantifiable data associated with navigating a webpage. Collecting the user interaction data may include downloading or receiving the data from one or more remote or local servers or other memory storage. The data may be collected in real time or compiled and received in data packets over a period of time. The data may be collected in response to a query or collected automatically at set intervals. The data may be useful for creating heatmaps or scroll maps that indicate where users spend most of the time scrolling or clicking on the webpage. System 300, external front end system 103, or internal front end system 105 may use the collected user interaction data to determine a current minimum detectable effect of success metrics indicative of a user experience at step 708.

A minimum detectable effect of success metrics indicative of a user experience represents the desired relative minimal improvement over the baseline and may indicate the smallest possible change that would be worth investing the time and money to implement a change permanently. System 300, external front end system 103, or internal front end system 105 may determine a current minimum detectable effect of a user experience at step 708 in real time or on a daily basis. The current minimum detectable effect may include trends of more than one observed value as well as discrete, individual values. The current minimum detectable effect may be stored in a local or remote memory. If the current minimum detectable effect of success metrics indicative of the user experience is greater than a desired minimum detectable effect or threshold, system 100 may predict minimum detectable effect over future days for the experiment. FIG. 6 illustrates a current minimum detectable effect at 640.

At step 710, system 300, external front end system 103, or internal front end system 105 retrieves a set of historic minimum detectable effect values associated with an earlier period of time. The historic values may be associated with one or more success metrics. The historic values may be retrieved from a local or remote memory, such as database 306, and may be retrieved over any wired or wireless communication channel. System 300, external front end system 103, or internal front end system 105 may organize or calibrate the historic values to align or coordinate with data for a current A/B test or testing experiment. The historic values may be related to one or more previously conducted experiments similar to the current experiment, and/or may be associated with similar success metrics as utilized in the current experiment. A set of historic minimum detectable effect values may include one or more historic minimum detectable effect values. For example, FIG. 5 illustrates a set including a plurality of historic minimum detectable effect values 510. FIG. 6 illustrates another example of a set of historic minimum detectable effect values at 601, 603, 605, and 607.

A percentile rank of the current minimum detectable effect based on the retrieved set of historic minimum detectable effect values is determined at step 712. A percentile rank may be determined by the following formula:

$$percentile rank = ( \frac{L}{N} ) * 10 \; 0 ,$$

where L is the number of data values that are less than or equal to the current minimum detectable effect and N is the size of the data set. When determining the percentile rank of the current minimum detectable effect 640 in the example shown in FIG. 6, the data set (N) includes the value for each of the historic minimum detectable effect values 601, 603, 605, and 607 for the current day (Dᵢ) (shown at 641, 642, 643, and 644) as well as the current minimum detectable effect 640. As such, N is equal to 5. Only one MDE value (644) is less than 640, therefore L is equal to 1. As such, percentile rank of the current minimum detectable effect 640 is (⅕)*100, or 20%.

A first future value of the minimum detectable effect of the user experience is predicted at step 714. The first future value of the minimum detectable effect of the user experience may be predicted by fitting a function to a curve of the current minimum detectable effect. The current minimum detectable may include any observed minimum detectable effect during the currently running A/B testing experiment. In one example, the interaction data may be used to determine a minimum detectable effect of one or more success metrics indicative of the user experience. FIG. 6 shows the minimum detectable effect for a current experiment at 600. In one aspect, the first future value of the minimum detectable effect of the user experience may be predicted by fitting a function to a curve of the minimum detectable effect for a current or active experiment. As shown, minimum detectable effect for a current experiment 600 includes an overall trend that may be used to fit a function to the data and extrapolate future data. Depending on the trend, the function may take the form of any equation, such as a simple linear equation or a complex polynomial equation. The function may be used to extrapolate a minimum detectable effect for a future day Dᵢ₊₁. A first future value of the minimum detectable effect of the user experience for future day Dᵢ₊₁ is shown at 630. The thicker dotted line is indicative of the function that has been fit to the minimum detectable effect for the current experiment 600.

At step 716, a second future value of the minimum detectable effect of the user experience is predicted. The second future value of the minimum detectable effect may be predicted by determining among the historic values, the historic minimum detectable effect value having a percentile rank equal to the percentile rank of the current minimum detectable effect. For example, as discussed above, the percentile rank of the current minimum detectable effect on day Dᵢ 640 is 20%. Therefore, the second future value is the historic minimum detectable effect value at day Dᵢ₊₁ having a percentile rank equal to 20%. The second future value is illustrated in FIG. 6 at 610.

At step 718, the first and second future values of the minimum detectable effect of the user experience are aggregated. The first and second future values may be aggregated in any manner that allows for consideration of both values. In one aspect, aggregating the first and second future values of the minimum detectable effect of the user experience includes averaging the first and second future values of the minimum detectable effect of the user experience. In another aspect, aggregating the first and second future values of the minimum detectable effect of the user experience includes a linear combination of the first and second future values of the minimum detectable effect of the user experience. In FIG. 6, the aggregated first and second value is shown at 620. In this example, first future value of the minimum detectable effect 630 and second future value of the minimum detectable effect 610 are averaged to result in the aggregated first and second future value 620.

A termination condition may be determined by system 300, external front end system 103, or internal front end system 105 using the current minimum detectable effect and the aggregated first and second future values. The termination condition may be based on a power, p-value, minimum detectable effect, or any other quantifiable value or threshold to allow for determination of statistical significance of an experiment. The termination condition may be based on a trend of the current minimum detectable effect and/or the aggregated first and second future values and/or any additional future values. The termination condition may be indicative of the current minimum detectable effect or the aggregated first and second future values being below a desired minimum detectable effect. At step 720 the system 300, external front end system 103, or internal front end system 105 may determine if a termination condition exists. If a termination condition exists, the experiment may be deemed complete. At this point, system 300, external front end system 103, or internal front end system 105 may cease sending the second webpage to the second user device at step 722. Sending the second webpage to the second user device may be stopped manually or automatically. In one aspect, a notification or indication may be transmitted to a user to stop the experiment, thus stopping the second webpage from being published. In another aspect, system 300, external front end system 103, or internal front end system 105 may automatically stop sending the second webpage and only send the first webpage, or may replace the first and second webpage with a third webpage. Additionally, if it is determined that a variable or at least one characteristic different than the first webpage is indicative of an increased user experience, the processor 302 may apply the at least one characteristic to a third webpage or marketing asset. Furthermore, if it is determined that the aggregated first and second future values is above a desired minimum detectable effect, then the method may continue and the aggregated first and second future value may become the basis for the next iteration of predictions at step 724 for calculating a third future value, a fourth future value, a fifth future value, and so on. For example, in the next iteration, the third future value may be determined by extrapolating the fitted function for the next time period, for example, Dᵢ₊₂. The percentile ranking of the aggregated value may be calculated and the fourth future value will be based on this percentile ranking. The third and fourth future values may be aggregated and then compared to a threshold or used in determining if a termination condition exists. In another aspect, rather than comparing the aggregated first and second future value (or any aggregated future value) directly to a desired minimum detectable effect, the aggregated first and second future value may be used in a calculation, the value then being compared to a threshold. For example, the aggregated first and second future value may be used to calculate a power of the experiment, which is then compared to a threshold power to determine statistical significance.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system, comprising:
memory comprising processor instructions; and
at least one processor configured to execute the instructions to perform steps comprising:
sending a first webpage to a first user device for presenting the first webpage in a first user interface of the first user device;
sending a second webpage to a second user device for presenting the second webpage in a second user interface of the second user device, wherein the second webpage comprises at least one content element not on the first webpage;
receiving, from the first user device, first user interaction data indicating interaction with the first webpage via the first user interface by a first user input in real time;
receiving, from the second user device, second user interaction data indicating interaction with the second webpage via the second user interface by a second user input in real time;
determining, based on the first user interaction data and the second user interaction data, whether a p-value between a characteristic of the first user interaction data and a corresponding characteristic of the second user interaction data is lower than a first threshold;
in response to a determination that the p-value is equal to or greater than the first threshold, determining, based on the first user interaction data and the second user interaction data, a current minimum detectable effect of success metrics indicative of a user experience;
retrieving a set of historic minimum detectable effect values for the success metrics associated with an earlier period of time;
determining a percentile rank of the current minimum detectable effect based on the retrieved set of historic minimum detectable effect values;
predicting a first future value of the minimum detectable effect of the user experience;
predicting a second future value of the minimum detectable effect of the user experience;
aggregating the first and second future values of the minimum detectable effect of the user experience;
determining, based on the current minimum detectable effect and the aggregated first and second future values, a termination condition; and
causing the second webpage to become unavailable to the second user device when the termination condition exists.

2. The computer-implemented system according to claim 1, wherein aggregating the first and second future values of the minimum detectable effect of the user experience includes averaging the first and second future values of the minimum detectable effect of the user experience.

3. The computer-implemented system according to claim 1, wherein aggregating the first and second future values of the minimum detectable effect of the user experience includes a linear combination of the first and second future values of the minimum detectable effect of the user experience.

4. The computer-implemented system according to claim 1, wherein the first future value is predicted by fitting a function to a curve of the current minimum detectable effect.

5. The computer-implemented system according to claim 4, wherein the second future value is predicted by determining among the historic values, a historic minimum detectable effect value having a percentile rank equal to the percentile rank of the current minimum detectable effect.

6. The computer-implemented system according to claim 1, wherein at least one processor is further configured to execute the instructions to perform steps comprising:
predicting a third future value of the minimum detectable effect of the user experience; and
predicting a fourth future value of the minimum detectable effect of the user experience.

7. The computer-implemented system according to claim 6, wherein at least one processor is further configured to execute the instructions to perform a step comprising:
aggregating the third and fourth future values of the minimum detectable effect of the user experience.

8. The computer-implemented system according to claim 7, wherein aggregating the third and fourth future values of the minimum detectable effect of the user experience includes at least one of an average of the third and fourth future values of the minimum detectable effect of the user experience or a linear combination of the third and fourth future values of the minimum detectable effect of the user experience.

9. The computer-implemented system according to claim 1, wherein at least one processor is further configured to execute the instructions to perform steps comprising:
determining if the at least one content element not on the first webpage is indicative of an increased user experience; and
adding the at least one content element not on the first webpage to a third webpage.

10. The computer-implemented system according to claim 1, wherein the at least one content element not on the first webpage comprises at least one difference in size, color, shape, position, location, order, spelling, wording, character, picture, image, frequency, level, brightness, hue, volume, visual feature, or audible feature.

11. A computer-implemented method, comprising:
sending a first webpage to a first user device for presenting the first webpage in a first user interface of the first user device;
sending a second webpage to a second user device for presenting the second webpage in a second user interface of the second user device,
wherein the second webpage comprises at least one content element not on the first webpage;
receiving, from the first user device, first user interaction data from indicating interaction with the first webpage via the first user interface by a first user input in real time;
receiving, from the second user device, second user interaction data indicating interaction with the second webpage via the second user interface by a second user input in real time;
determining, based on the first user interaction data and the second user interaction data, whether a p-value between a characteristic of the first user interaction data and a corresponding characteristic of the second user interaction data is lower than a first threshold;
in response to a determination that the p-value is equal to or greater than the first threshold, determining, based on the first user interaction data and the second user interaction data, a current minimum detectable effect of success metrics indicative of a user experience;
retrieving a set of historic minimum detectable effect values for the success metrics associated with an earlier period of time;
determining a percentile rank of the current minimum detectable effect based on the retrieved set of historic minimum detectable effect values;
predicting a first future value of the minimum detectable effect of the user experience;
predicting a second future value of the minimum detectable effect of the user experience;
aggregating the first and second future values of the minimum detectable effect of the user experience;
determining, based on the current minimum detectable effect and the aggregated first and second future values, a termination condition; and
causing the second webpage to become unavailable to the second user device when the termination condition exists.

12. The computer-implemented method according to claim 11, wherein aggregating the first and second future values of the minimum detectable effect of the user experience includes averaging the first and second future values of the minimum detectable effect of the user experience.

13. The computer-implemented method according to claim 11, wherein aggregating the first and second future values of the minimum detectable effect of the user experience includes a linear combination of the first and second future values of the minimum detectable effect of the user experience.

14. The computer-implemented method according to claim 11, wherein the first future value is predicted by fitting a function to a curve of the current minimum detectable effect.

15. The computer-implemented method according to claim 14, wherein the second future value is predicted by determining a historic minimum detectable effect value having a percentile rank equal to the percentile rank of the current minimum detectable effect.

16. The computer-implemented method according to claim 11, further comprising:
predicting a third future value of the minimum detectable effect of the user experience;
predicting a fourth future value of the minimum detectable effect of the user experience; and
aggregating the third and fourth future values of the minimum detectable effect of the user experience.

17. The computer-implemented method according to claim 16, wherein aggregating the third and fourth future values of the minimum detectable effect of the user experience includes at least one of an average of the third and fourth future values of the minimum detectable effect of the user experience or a linear combination of the third and fourth future values of the minimum detectable effect of the user experience.

18. The computer-implemented method according to claim 11, further comprising:
determining if the at least one content element not on the first webpage is indicative of an increased user experience; and
adding the at least one content element not on the first webpage to a third webpage.

19. The computer-implemented method according to claim 11, wherein the at least one content element not on the first webpage comprises at least one difference in size, color, shape, position, location, order, spelling, wording, character, picture, image, frequency, level, brightness, hue, volume, visual feature, or audible feature.

20. A computer-implemented system, comprising:
memory comprising processor instructions; and
at least one processor configured to execute the instructions to perform steps comprising:
sending a first webpage to a first user device for presenting the first webpage in a first user interface of the first user device;
sending a second webpage to a second user device for presenting the second webpage in a second user interface of the second user device, wherein the second webpage comprises at least one content element not on the first webpage;
receiving, from the first user device, first collecting user interaction data indicating interaction with the first webpage via the first user interface by a first user input in real time;
receiving, from the second user device, second user interaction data indicating interaction with the second webpage via the second user interface by a second user input in real time;
determining, based on the first user interaction data and the second user interaction data, whether a p-value between a characteristic of the first user interaction data and a corresponding characteristic of the second user interaction data is lower than a first threshold;
in response to a determination that the p-value is equal to or greater than the first threshold, determining, based on the first user interaction data and the second user interaction data, a current minimum detectable effect of success metrics indicative of a user experience;
retrieving a set of historic minimum detectable effect values for the success metrics associated with an earlier period of time;
determining a percentile rank of the current minimum detectable effect based on the retrieved set of historic minimum detectable effect values;
predicting a first future value of the minimum detectable effect of the user experience;
predicting a second future value of the minimum detectable effect of the user experience;
aggregating the first and second future values of the minimum detectable effect of the user experience; and
determining, based on the current minimum detectable effect and the aggregated first and second future values of the minimum detectable effect of the user experience, to continue sending the second webpage to the second user device if the current minimum detectable effect and the aggregated first and second future values are not indicative of a termination condition, and causing the second webpage to become unavailable to the second user device if the current minimum detectable effect and the aggregated first and second future values are indicative of a termination condition.
